(19) United States
(12) Patent Application Publication
(10) Pub. No.: US 2026/0140235 A1
(43) Pub. Date: May 21, 2026

(54) FOCAL PLANE ARRAY AND LIDAR DEVICE INCLUDING THE SAME

(71) Applicant: SAMSUNG ELECTRONICS CO., LTD., Suwon-si (KR)

(72) Inventors: Jangwoo YOU, Suwon-si (KR); Sangyun PARK, Suwon-si (KR); Jinwoo CHOI, Suwon-si (KR); Sunil KIM, Suwon-si (KR); Minkyung LEE, Suwon-si (KR)

(73) Assignee: SAMSUNG ELECTRONICS CO., LTD., Suwon-si (KR)

(21) Appl. No.: 19/187,325

(22) Filed: Apr. 23, 2025

(30) Foreign Application Priority Data
Nov. 21, 2024 (KR) 10-2024-0167752

(51) Int. Cl. G01S 7/481; G01S 7/499

(52) U.S. Cl. CPC G01S 7/4814; G01S 7/4816; G01S 7/499

(57) ABSTRACT

A focal plane array may include a plurality of pixels configured to output a transmission light beam to a target object and receive, based on the transmission light beam, a reception light beam reflected from the target object, wherein each of the plurality of pixels includes a transmission grating coupler, a reception grating coupler, and a geometric phase geometric phase optical device.

### CROSS-REFERENCE TO RELATED APPLICATION

This application is based on and claims priority under 35 U.S. C. § 119 to Korean Patent Application No. 10-2024-0167752, filed on Nov. 21, 2024, in the Korean Intellectual Property Office, the disclosure of which is incorporated by reference herein in its entirety.

### BACKGROUND

### 1. Field

Some embodiments of the disclosure relate to a focal plane array and a light detection and ranging (LiDAR) device including the focal plane array, and more particularly, to a grating coupler structure of a focal plane array capable of splitting a light path and reducing light loss.

### 2. Description of Related Art

Light detection and ranging (LiDAR) technology based on silicon photonics is classified into direct time of flight (DTOF), indirect time of flight (ITOF), and frequency-modulated continuous wave (FMCW) depending on the method of measuring a distance. Among these, in the case of the FMCW method, a frequency-modulated light signal is transmitted from a transmitter and the frequency of a signal obtained from a receiver is measured to calculate the distance to and speed of a target object. The FMCW method has high range resolution and velocity resolution even in environments with ambient noise, and is particularly suitable for implementing silicon photonics-based LiDAR when it is difficult to secure high optical thrust because a light source with low peak power may be used.

Beam scanning methods using silicon photonics include a method of using an optical phased array (OPA), a method of using a focal plane array (FPA), etc. Among these, the method of using an FPA with low complexity and excellent side mode suppression ratio (SMSR) is suitable for use with an FMCW driving method.

### SUMMARY

According to some embodiments of the present disclosure, a focal plane array and a light detection and ranging (LiDAR) device including the focal plane array may be provided and have a grating coupler structure capable of splitting a light path and reducing light loss.

According to some embodiments of the present disclosure, a focal plane array may be provided and include: a plurality of pixels configured to output a transmission light beam to a target object and receive, based on the transmission light beam, a reception light beam reflected from the target object, wherein each of the plurality of pixels includes: a transmission grating coupler; a reception grating coupler, and a geometric phase (GP) optical device, wherein the transmission grating coupler is configured to output the transmission light beam such that the transmission light beam has a first polarization direction and is incident on the GP optical device, and the GP optical device is configured to modulate the transmission light beam from the first polarization direction to a second polarization direction, different from the first polarization direction, and wherein the reception light beam reflected from the target object has a third polarization direction, the GP optical device is further configured to modulate the reception light beam from the third polarization direction to a fourth polarization direction, different form the third polarization direction, and the reception grating coupler is further configured to receive the reception light beam having the fourth polarization direction.

According to one or more embodiments of the present disclosure, the GP optical device is a GP lens, a GP deflector, or a GP deflector lens, and the GP optical device includes a liquid crystal or a plurality of nanostructures, the first polarization direction is one from among a left-circular polarization and a right-circular polarization, the second polarization direction is one from among the left-circular polarization and the right-circular polarization that is different from the first polarization direction, and the third polarization direction is one from among the left-circular polarization and the right-circular polarization, and the fourth polarization direction is one from among the left-circular polarization and the right-circular polarization that is different from the third polarization direction.

According to one or more embodiments of the present disclosure, the GP optical device is the GP lens, the first polarization direction and the fourth polarization direction are each either the left-circular polarization or the right-circular polarization, and the second polarization direction and the third polarization direction are each either the left-circular polarization or the right-circular polarization that is different from the first polarization direction and the fourth polarization direction, respectively.

According to one or more embodiments of the present disclosure, the GP optical device is a GP lens, the transmission grating coupler is larger than the reception grating coupler, and the reception grating coupler is on the transmission grating coupler.

According to one or more embodiments of the present disclosure, the GP optical device is the GP lens, the reception grating coupler is larger than the transmission grating coupler, and the transmission grating coupler is on the reception grating coupler.

According to one or more embodiments of the present disclosure, the GP optical device is the GP lens, and the focal plane array further includes a quarter wave plate between the transmission grating coupler and the GP optical device.

According to one or more embodiments of the present disclosure, each of the plurality of pixels further includes a buried oxide (BOX) layer, and a cladding layer on the BOX layer, the reception grating coupler is on the BOX layer, the transmission grating coupler is on the cladding layer and apart from the reception grating coupler, and the GP optical device and the quarter wave plate overlap with the cladding layer and are apart from the transmission grating coupler.

According to one or more embodiments of the present disclosure, each of the plurality of pixels further includes a buried oxide (BOX) layer, and a cladding layer on the BOX layer, the reception grating coupler is on the BOX layer, the transmission grating coupler is in the cladding layer and apart from the reception grating coupler, the focal plane array further includes a substrate that is apart from the cladding layer, and the GP optical device and the quarter wave plate are on the substrate.

According to one or more embodiments of the present disclosure, the GP optical device is the GP deflector, the first polarization direction and the third polarization direction are each one from among the left-circular polarization or the right-circular polarization, and the second polarization direction and the fourth polarization direction are each the other from among the left-circular polarization and the right-circular polarization.

According to one or more embodiments of the present disclosure, the GP optical device is the GP deflector, each of the plurality of pixels further includes a buried oxide (BOX) layer, and a cladding layer on the BOX layer, and the transmission grating coupler and the reception grating coupler are spaced apart from each on the BOX layer, and extend in opposite directions with respect to each other.

According to one or more embodiments of the present disclosure, the GP optical device is the GP deflector, each of the plurality of pixels further includes a buried oxide (BOX) layer, and a cladding layer provided on the BOX layer, the transmission grating coupler and the reception grating coupler are spaced apart from each other on the BOX layer, and extend in opposite directions with respect to each other, the focal plane array further includes a substrate that is apart from the cladding layer, and the GP optical device is on the substrate.

According to one or more embodiments of the present disclosure, the GP optical device is the GP lens, the focal plane array further includes a quarter wave plate that is between the transmission grating coupler and the GP optical device and between the reception grating coupler and the GP optical device, each of the plurality of pixels further includes a buried oxide (BOX) layer, and a cladding layer provided on the BOX layer, and the transmission grating coupler and the reception grating coupler are spaced apart from each other on the BOX layer, and extend perpendicular to each other.

According to one or more embodiments of the present disclosure, the GP optical device is the GP lens, the focal plane array further includes a quarter wave plate between the transmission grating coupler and the GP optical device and between the reception grating coupler and the GP optical device, each of the plurality of pixels further includes a buried oxide (BOX) layer. and a cladding layer on the BOX layer, the transmission grating coupler and the reception grating coupler are spaced apart from each other on the BOX layer, and extend perpendicular to each other, the focal plane array further includes a substrate that is apart from the cladding layer, and the GP optical device and the quarter wave plate are on the substrate.

According to one or more embodiments of the present disclosure, the GP optical device is the GP deflector lens, the first polarization direction and the third polarization direction are each one from among the left-circular polarization and the right-circular polarization, and the second polarization direction and the fourth polarization direction are each the other from among the left-circular polarization and the right-circular polarization.

According to one or more embodiments of the present disclosure, the GP optical device is a GP deflector lens, each of the plurality of pixels further includes a buried oxide (BOX) layer, and a cladding layer on the BOX layer, and the transmission grating coupler and the reception grating coupler are on the BOX layer, and extend in opposite directions with respect to each other.

According to one or more embodiments of the present disclosure, the GP optical device is a GP deflector lens, the focal plane array further includes a quarter wave plate between the transmission grating coupler and the GP deflector lens, and the reception grating coupler and the GP deflector lens, each of the plurality of pixels further includes a buried oxide (BOX) layer, and a cladding layer on the BOX layer, and the transmission grating coupler and the reception grating coupler are on the BOX layer, and extend perpendicular to each other.

According to one or more embodiments of the present disclosure, the focal plane array further includes: a first waveguide connected to the transmission grating coupler; and a second waveguide connected to the reception grating coupler, and an angle between the first waveguide and the second waveguide is 0 degrees, 90 degrees, or 180 degrees.

According to embodiments of the present disclosure, a light detection and ranging (LiDAR) device may be provided and include: a light source configured to output a light; a steerer configured to steer the light; a detector configured to detect the light after the light is reflected; and a processor configured to perform an operation based on the light that is detected by the detector, wherein the steerer includes: a plurality of pixels configured to output a transmission light beam to a target object and receive, based on the transmission light beam, a reception light beam reflected from the target object, wherein each of the plurality of pixels includes: a transmission grating coupler; a reception grating coupler; and a geometric phase (GP) optical device, wherein the transmission grating coupler is configured to output the transmission light beam such that the transmission light beam has a first polarization direction and is incident on the GP optical device, and the GP optical device is configured to modulate the transmission light beam from the first polarization direction to a second polarization direction, and wherein the reception light beam reflected from the target object has a third polarization direction, the GP optical device is further configured to modulate the reception light beam from the third polarization direction to a fourth polarization direction, and the reception grating coupler is further configured to receive the reception light beam having the fourth polarization direction.

According to one or more embodiments of the present disclosure, the GP optical device is a GP lens, a GP deflector, or a GP deflector lens, the first polarization direction is one from among a left-circular polarization and a right-circular polarization, the second polarization direction is one from among the left-circular polarization and the right-circular polarization that is different from the first polarization direction, and the third polarization direction is one from among the left-circular polarization and the right-circular polarization, and the fourth polarization direction is one from among the left-circular polarization and the right-circular polarization that is different from the third polarization direction.

According to one or more embodiments of the present disclosure, the transmission grating coupler and the reception grating coupler are vertically stacked on each other, or are on a same vertical level as each other.

Additional aspects will be set forth in part in the description which follows and, in part, will be apparent from the description, or may be learned by practice of the presented embodiments of the disclosure.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a schematic view of a focal plane array according to an embodiment;

FIG. 2 is a schematic view showing pixels of FIG. 1;

FIGS. 3 to 5 are schematic views showing a grating coupler according to an embodiment;

FIGS. 6A to 6B show a waveguide structure of a transmission grating coupler and a reception grating coupler according to embodiments;

FIGS. 7 to 9 are schematic views of a grating coupler according to an embodiment;

FIGS. 10A to 10B are schematic views of a grating coupler according to embodiments;

FIGS. 11 to 13 are schematic views of a grating coupler according to an embodiment;

FIGS. 14 and 15 are schematic views of a grating coupler according to an embodiment;

FIGS. 16 to 18 are schematic views of a grating coupler according to an embodiment;

FIGS. 19 to 21 are schematic views of a grating coupler according to an embodiment;

FIGS. 22 to 24 are schematic views of a grating coupler according to an embodiment; and

FIG. 25 shows a light detection and ranging (LiDAR) device according to an embodiment.

### DETAILED DESCRIPTION

Reference will now be made in detail to non-limiting example embodiments of the present disclosure, examples of which are illustrated in the accompanying drawings, wherein like reference numerals refer to like elements throughout. In this regard, embodiments of the present disclosure may have different forms and should not be construed as being limited to the descriptions set forth herein. Accordingly, the example embodiments are merely described below, by referring to the figures, to explain example aspects of the present disclosure. As used herein, the term “and/or” includes any and all combinations of one or more of the associated listed items. Expressions such as “at least one of,” when preceding a list of elements, modify the entire list of elements and do not modify the individual elements of the list.

Hereinafter, a focal plane array (FPA) and a light detection and ranging (LiDAR) device including the same are described in detail with reference to the accompanying drawings. In the drawings, like reference numerals refer to the like elements, and sizes of elements in the drawings may be exaggerated for clarity and convenience of explanation. In addition, the following example embodiments described below are merely illustrative, and various modifications may be possible from the example embodiments.

It will be understood that when an element or layer is referred to as being “on” or “above” another element or layer, the element or layer may be directly on another element or layer or intervening elements or layers. An expression used in the singular encompasses the expression of the plural, unless it has a clearly different meaning in the context. Also, it should be understood that, when a part “comprises” or “includes” an element in the specification, unless otherwise defined, other elements are not excluded from the part and the part may further include other elements.

The use of the terms of “the above-described” and similar indicative terms may correspond to both the singular forms and the plural forms. Also, the steps of all methods described herein can be performed in any suitable order unless otherwise indicated herein or otherwise clearly contradicted by context. Embodiments are not limited to the described order of the steps.

The connection or connection members of the lines between the elements shown in the drawing are examples of functional connection and/or physical or circuit connections, and may be replaced or be implemented as various functional connections, physical connections, or circuit connections in an actual apparatus.

The use of any and all examples, or exemplary language provided herein, is intended merely to better illuminate embodiments and does not pose a limitation on the scope of embodiments of the present disclosure unless otherwise stated.

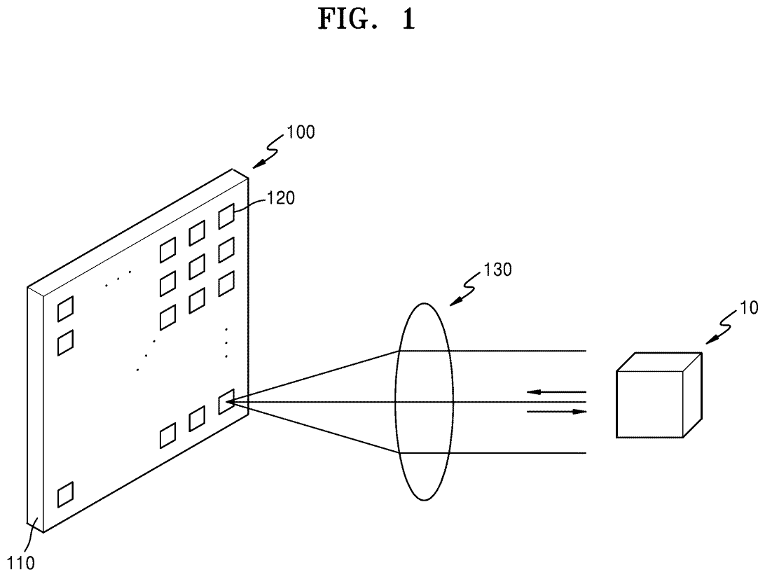

FIG. 1 is a schematic view of an FPA 100 according to an embodiment.

Referring to FIG. 1, the FPA 100 may be provided on a focal plane of an imaging lens 130. The FPA 100 may include a photonic integrated circuit (PIC) 110 and a plurality of pixels 120. The plurality of pixels 120 may be two-dimensionally arranged along a first direction (e.g., an X direction) and a second direction (e.g., a Y direction) in or on the PIC 110. The plurality of pixels 120 of the FPA 100 may be selectively activated to two-dimensionally scan one or more light beams. Each of the plurality of pixels 120 may transmit a light beam in a specific direction and receive a light beam reflected from a target object 10.

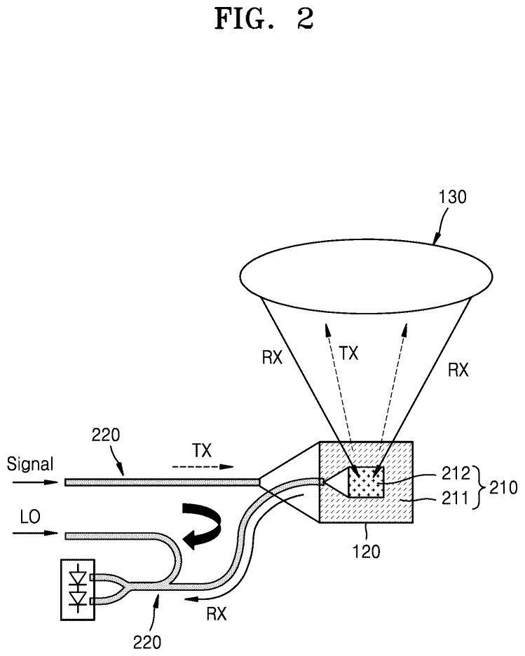

FIG. 2 is a schematic view of the plurality of pixels of FIG. 1.

Referring to FIG. 2, each of the plurality of pixels 120 may include a grating coupler 210 and a waveguide 220. The grating coupler 210 may include a transmission grating coupler 211 and a reception grating coupler 212. A direction of a transmission light beam Tx transmitted along the waveguide 220 may be changed by the transmission grating coupler 211 such that the transmission light beam Tx passes through the imaging lens 130 and then is transmitted to the target object 10 (see FIG. 1). A reception light beam Rx reflected from the target object 10 may pass through the imaging lens 130, may be received by the reception grating coupler 212, may be interfered with by a local oscillator light beam LO, and then may be measured by a balanced photodiode (BPD). Hereinafter, the structure of the grating coupler 210 that may be applied to each pixel 120 is described.

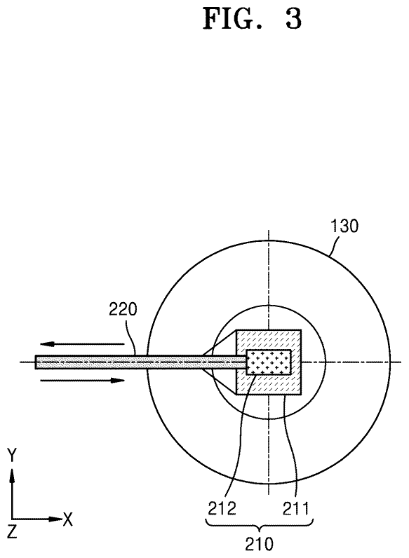

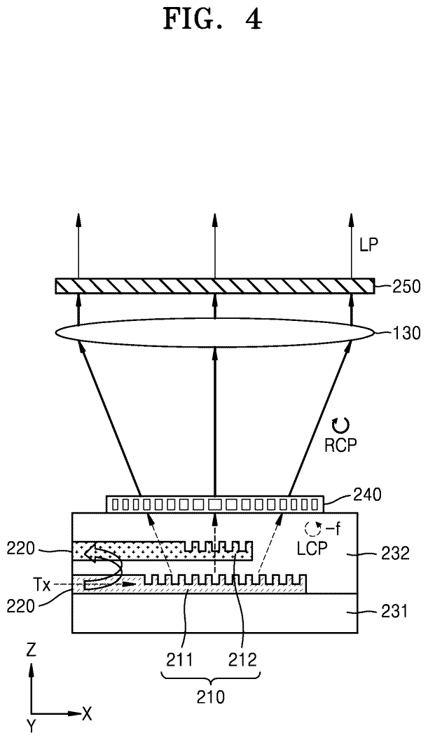

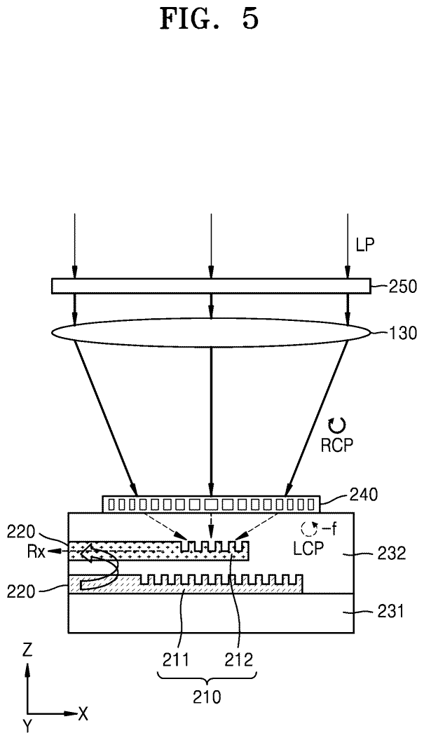

FIGS. 3 to 5 are schematic views showing the grating coupler 210 according to an embodiment. FIG. 3 shows a front view of the grating coupler 210 according to an embodiment, and FIGS. 4-5 shows side views of the grating coupler 210 according to an embodiment.

Referring to FIGS. 3 to 5, the transmission grating coupler 211 and the reception grating coupler 212 of the grating coupler 210 may face each other and be apart from each other in a third direction (e.g., a Z direction). For example, the transmission grating coupler 211 may be provided on a buried oxide (BOX) layer 231 and the reception grating coupler 212 may be provided at a certain distance from the transmission grating coupler 211 in the third direction (e.g., the Z direction). The structure may be referred to as a vertical stack structure. A cladding layer 232 may be provided on the BOX layer 231. The transmission grating coupler 211, the reception grating coupler 212, and the waveguide 220 may be provided in the cladding layer 232. A geometric phase (GP) optical device (e.g., a GP lens 240) may be provided on the cladding layer 232. The GP optical device may include a liquid crystal or a plurality of nanostructures. The GP lens 240 may include liquid crystals or a plurality of nanostructures. The nanostructures may form a meta surface.

Referring to FIG. 4, the light beam output from the transmission grating coupler 211 may be, for example, a left-circularly polarized light beam LCP. The GP lens 240 may modulate the left-circularly polarized light beam LCP output from the transmission grating coupler 211 to a right-circularly polarized light beam RCP, and the GP lens 240 may operate as a lens having negative power (−f) with respect to the left-circularly polarized light beam LCP. The light beam passed through the GP lens 240 may be modulated to a right-circularly polarized light beam RCP and the divergence of the light beam may increase. After being right-circularly polarized RCP, the light beam passed through the imaging lens 130 may be collimated and directed to a quarter wave plate (QWP) 250, and the light beam passed through the QWP 250 may be linearly polarized LP and directed to a target object (e.g., the target object 10).

Referring to FIG. 5, a light beam reflected from a target object (e.g., the target object 10) may be in a linearly polarized state (e.g., may be a linearly polarized light beam LP), and the linearly polarized light beam LP may be polarized to a right-circularly polarized light beam RCP by passing through the QWP 250. The right-circular polarized RCP light beam may pass through the imaging lens 130, focused, and then directed to the GP lens 240. The GP lens 240 may modulate a right-circularly polarized light beam RCP to a left-circularly polarized light beam LCP and the GP lens 240 may operate as a lens having positive power (+f) with respect to the right-circularly polarized light beam RCP. The light beam passed through the GP lens 240 may be modulated to a left-circularly polarized light beam LCP and focused by the reception grating coupler 212.

The sizes (e.g., areas) of the transmission grating coupler 211 and the reception grating coupler 212 may be different from each other. For example, the reception grating coupler 212 may be smaller than the transmission grating coupler 211. A solid angle (Ω) of the transmission light beam Tx output from the transmission grating coupler 211 having an area A may be increased by passing through the GP lens 240, and a solid angle (Ω′) of the reception light beam Rx reflected from an object may be additionally increased, thereby allowing the reception light beam RX to be focused on the reception grating coupler 212 having an area A′. Since AΩ≤A′Ω′ is satisfied according to the Etendue conservation law, as the solid angle (Ω′) of the reception light beam Rx is increased compared to the solid angle (Ω) of the transmission light beam Tx, the area of the reception grating coupler 212 may be smaller than the area of the transmission grating coupler 211.

As sizes of the transmission grating coupler 211 and the reception grating coupler 212 are different from each other, and an output position of the transmission light beam Tx of the transmission grating coupler 211 and a focusing position of the reception light beam Rx of the reception grating coupler 212 are different from each other, the transmission grating coupler 211 and the reception grating coupler 212 may have a vertically stacked structure, and optical paths of the transmission Tx light and the reception Rx light may be separated.

For convenience, an example wherein the light beam output from the transmission grating coupler 211 is left-circularly polarization LCP, modulated to a right-circularly polarized light beam RCP by the GP lens 240, linearly polarized by the QWP 250, directed to the target object (e.g., the target object 10), reflected from the target object (e.g., the target object 10), right-circularly polarized RCP by the QWP 250, and then left-circularly polarized LCP by the GP lens 240 is illustrated. However, on the other hand, the light beam output from the transmission grating coupler 211 may be right-circularly polarized RCP, modulated to a left-circularly polarized light beam LCP by the GP lens 240, linearly polarized by the QWP 250, directed to the target object (e.g., the target object 10), reflected from the target object (e.g., the target object 10), left-circularly polarized LCP by the QWP 250, and modulated to a right-circularly polarized RCP by the GP lens 240. The same applies to the below embodiments.

In addition, FIGS. 3 to 5 show an example wherein the waveguide 220 of the transmission grating coupler 211 and the waveguide 220 of the reception grating coupler 212 are formed in the same direction, but the waveguide 220 of the transmission grating coupler 211 and the waveguide 220 of the reception grating coupler 212 may have various structures as described below.

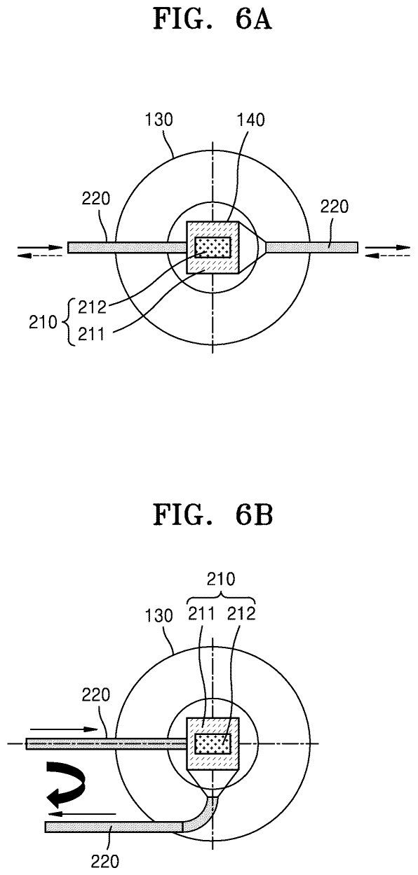

FIGS. 6A to 6B are views of the waveguide structure (e.g., a structure of waveguides 220) of the transmission grating coupler 211 and the reception grating coupler 212 according to embodiments.

Referring to FIG. 6A, the waveguide 220 of the transmission grating coupler 211 and the waveguide 220 of the reception grating coupler 212 may be provided in opposite directions from each other. For example, the waveguide 220 of the transmission grating coupler 211 may be connected to a first side (e.g., a left side in FIG. 6A) of the transmission grating coupler 211 and the waveguide 220 of the reception grating coupler 212 may be connected to a second side (e.g., a right side in FIG. 6A) of the reception grating coupler 212, that is opposite to the first side. For example, the waveguide 220 of the transmission grating coupler 211 and the waveguide 220 of the reception grating coupler 212 may extend in parallel on opposite sides of the grating coupler 210, respectively.

Alternatively, referring to FIG. 6B, the waveguide 220 of the transmission grating coupler 211 and the waveguide 220 of the reception grating coupler 212 may be provided at approximately a 90° angle with respect to each other. For example, the waveguide 220 of the transmission grating coupler 211 may be connected to a first side (e.g., a left side in FIG. 6A) of the transmission grating coupler 211 and the waveguide 220 of the reception grating coupler 212 may be connected to a third side (e.g., a bottom side in FIG. 6A) of the reception grating coupler 212, that crosses (e.g., is perpendicular) to the first side. According to some embodiments, the waveguide 220 of the transmission grating coupler 211 and the waveguide 220 of the reception grating coupler 212 may be connected to different sides (e.g., the first side and the third side) of the grating coupler 210, but may extend in parallel at the first side (e.g., left side) of the grating coupler 210.

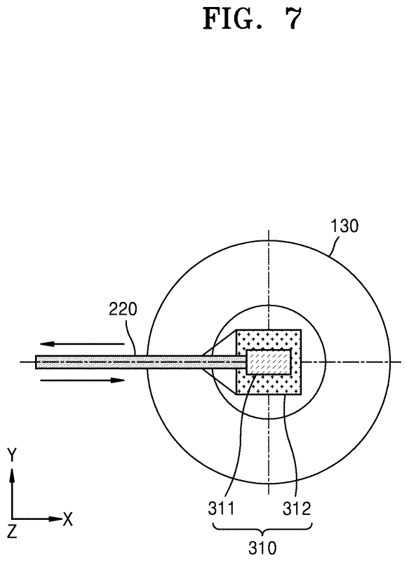

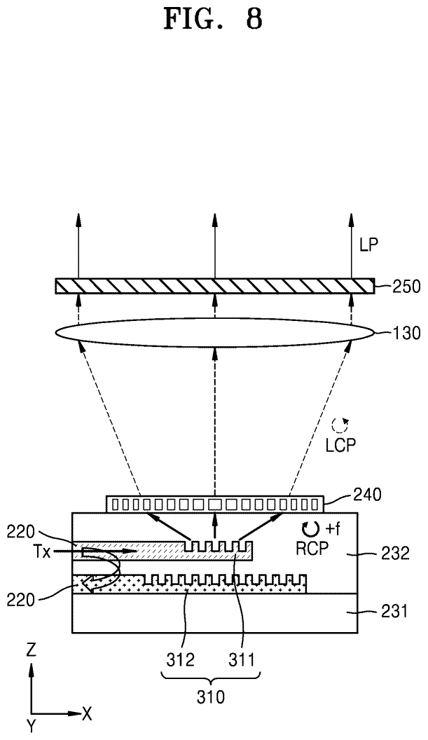

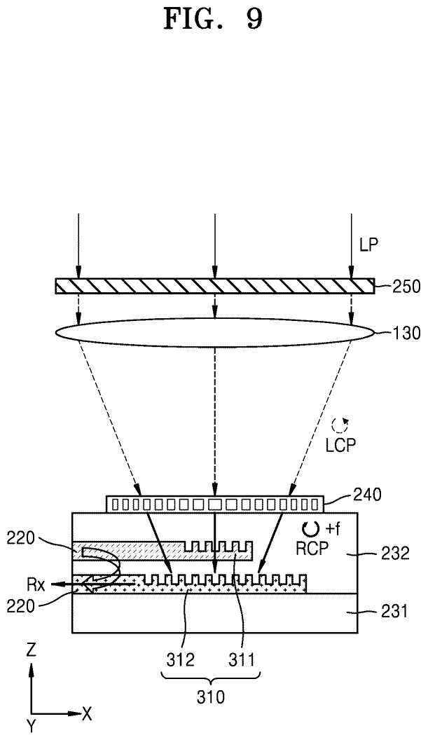

FIGS. 7 to 9 are schematic views of a grating coupler 310 according to some embodiments. FIG. 7 shows a front view of the grating coupler 310 according to an embodiment, and FIGS. 8-9 show side views of the grating coupler 310 according to an embodiment. Differences between elements are described with reference to FIGS. 3 to 5, and repeated descriptions may be omitted.

Referring to FIGS. 7 to 9, a reception grating coupler 312 may be larger than a transmission grating coupler 311. In addition, the reception grating coupler 312 may be provided on the BOX layer 231 and the transmission grating coupler 311 may be provided at a certain distance from the reception grating coupler 312 in the third direction (e.g., the Z direction). For example, the reception grating coupler 310 may be between the transmission grating coupler 311 and the BOX layer 231. The structure may be referred to as a vertical stack structure.

Referring to FIG. 8, a light beam output from the transmission grating coupler 311 may be a right-circularly polarized light beam RCP. The GP lens 240 may modulate the right-circularly polarized light beam RCP output from the transmission grating coupler 311 to the left-circularly polarized light beam LCP, and the GP lens 240 may operate as a lens having positive power (+f) with respect to the left-circularly polarized light beam LCP. The light beam passed through the GP lens 240 may be modulated to a left-circularly polarized light beam LCP and the divergence thereof may be reduced. After being left-circularly polarized LCP, the light beam passed through the imaging lens 130 may be collimated and directed to the QWP 250, and the light beam passed through the QWP 250 may be linearly polarized LP and directed to a target object (e.g., the target object 10).

Referring to FIG. 9, a light beam reflected from a target object (e.g., the target object 10) may be in a linearly polarized LP state, and the linearly polarized LP light beam may be polarized to a left-circularly polarized light beam LCP by passing through the QWP 250. The light beam that is left-circularly polarized LCP may pass through the imaging lens 130 to be focused and then directed to the GP lens 240. The GP lens 240 may polarize the left-circularly polarized light beam LCP to a right-circularly polarized light beam RCP, and the GP lens 240 may operate as a lens having negative power (−f) with respect to the left-circularly polarized light beam LCP. The light beam passed through the GP lens 240 may be polarized to a right-circularly polarized light beam RCP and have increased divergence to be directed to the reception grating coupler 212.

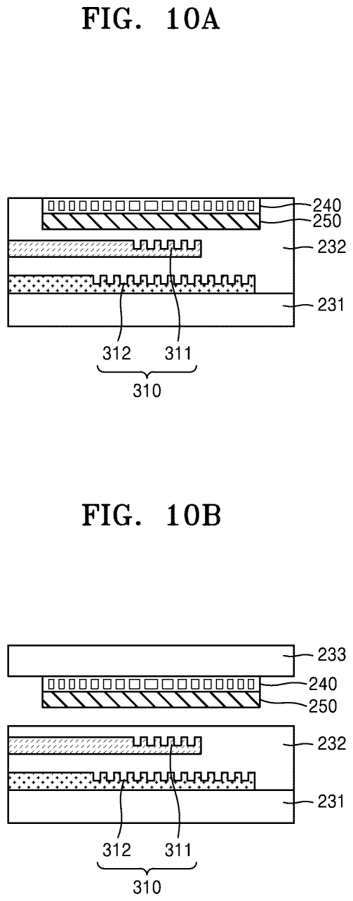

FIGS. 10A to 10B are schematic views of the grating coupler 310 according to some embodiments. Differences between elements are described with reference to FIGS. 7 to 9, and repeated descriptions may be omitted.

Referring to FIG. 10A, the GP lens 240 may be provided in the cladding layer 232, and the QWP 250 may be additionally provided below the GP lens 240 in the cladding layer 232. Alternatively, referring to FIG. 10B, the GP lens 240 may be provided below a separate substrate 233, outside of the cladding layer 232, and the QWP 250 may be provided below the GP lens 240, outside of the cladding layer 232. In this case, the transmission grating coupler 311 and the reception grating coupler 212 may be configured to couple linearly polarized light and the QWP 250 may convert the linearly polarized light into circularly polarized light.

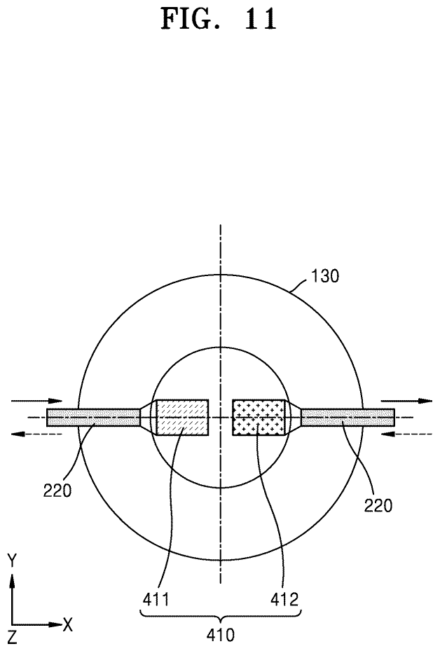

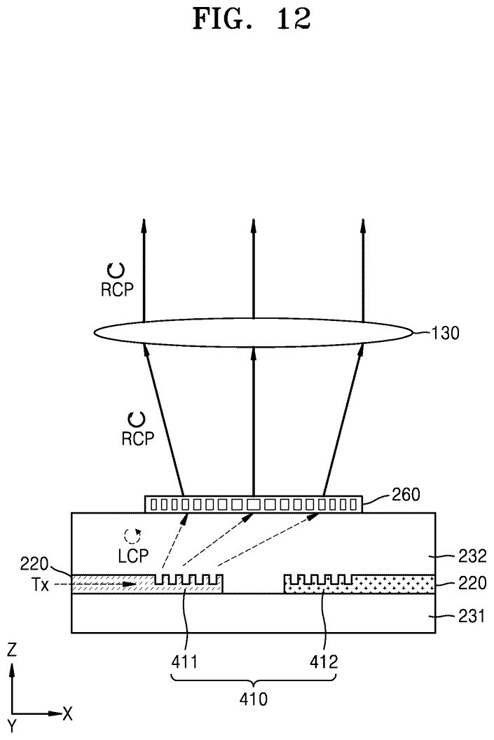

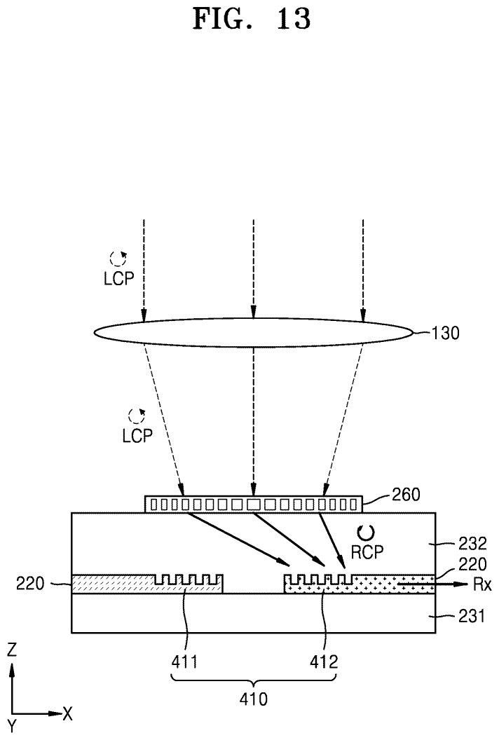

FIGS. 11 to 13 are schematic views showing a grating coupler 410 according to some embodiments. FIG. 11 shows a front view of the grating coupler 410 according to an embodiment, and FIGS. 12-13 shows side views of the grating coupler 410 according to an embodiment. Differences between elements are described with reference to FIGS. 3 to 5, and repeated descriptions may be omitted.

Referring to FIGS. 11 to 13, a transmission grating coupler 411 and a reception grating coupler 412 may be provided on the BOX layer 231, and the transmission grating coupler 411 and the reception grating coupler 412 may be provided on the same level in the third direction (e.g., the Z direction). The structure may be referred to as a horizontal structure. The transmission grating coupler 411 and the reception grating coupler 412 may be provided on the BOX layer 231 in opposite directions and be apart from each other by a certain distance in the first direction (e.g., the X direction). A GP optical device (e.g., a GP deflector 260) may be provided on the cladding layer 232. The GP deflector 260 may include liquid crystals or a plurality of nanostructures. The nanostructures may constitute a meta surface.

Referring to FIG. 12, a light beam output from the transmission grating coupler 411 may be a left-circularly polarized light beam LCP. The GP deflector 260 may polarize the left-circularly polarized light beam LCP output from the transmission grating coupler 411 to a right-circularly polarized light beam RCP, and the GP deflector 260 may refract the left-circularly polarized light beam LCP toward the imaging lens 130. A light beam passed through the GP deflector 260 may be modulated to a right-circularly polarized light beam RCP and refracted toward the imaging lens 130. After being right-circularly polarized, the light beam passed through the imaging lens 130 may be collimated and directed toward the target object (e.g., the target object 10).

Referring to FIG. 13, the right-circularly polarized light beam RCP may be polarized to a left-circularly polarized light beam LCP after being reflected from an object (e.g., the target object 10). The light beam that is left-circularly polarized may pass through the imaging lens 130 to be focused and then directed to the GP deflector 260. The GP deflector 260 may polarize the left-circularly polarized light beam LCP to a right-circularly polarized light beam RCP and may deflect the light beam, that was previously left-circularly polarized, toward the reception grating coupler 412. The light beam passed through the GP deflector 260 may be modulated to a right-circularly polarized light beam RCP and may be incident on the reception grating coupler 412.

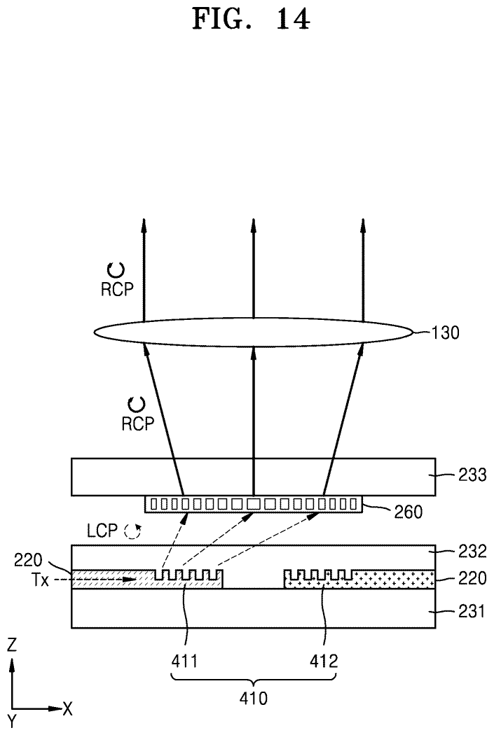

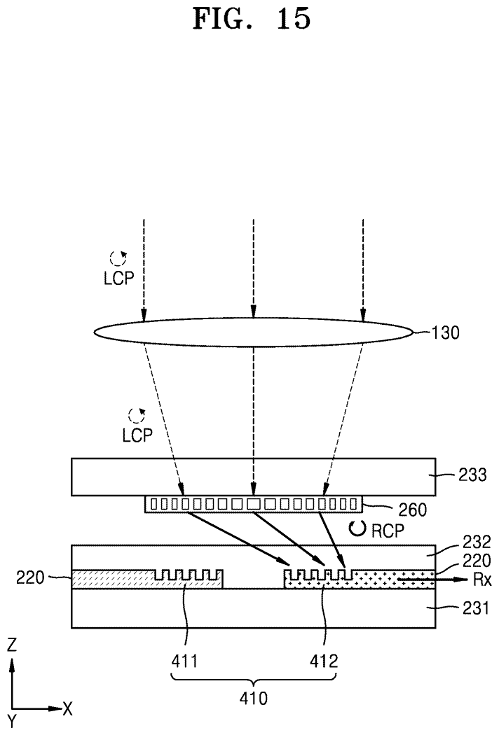

FIGS. 14 and 15 are schematic views showing the grating coupler 410 according to some embodiments. Differences between elements are described with reference to FIGS. 11 to 13, and repeated descriptions may be omitted.

Referring to FIGS. 14 and 15, the transmission grating coupler 411 and the reception grating coupler 412 may be provided on the BOX layer 231, and the transmission grating coupler 411 and the reception grating coupler 412 may be provided on the same level in the third direction (the Z direction). The separate substrate 233 may be provided at a certain distance from the cladding layer 232 in the third direction (the Z direction) and the GP deflector 260 may be provided below the separate substrate 233.

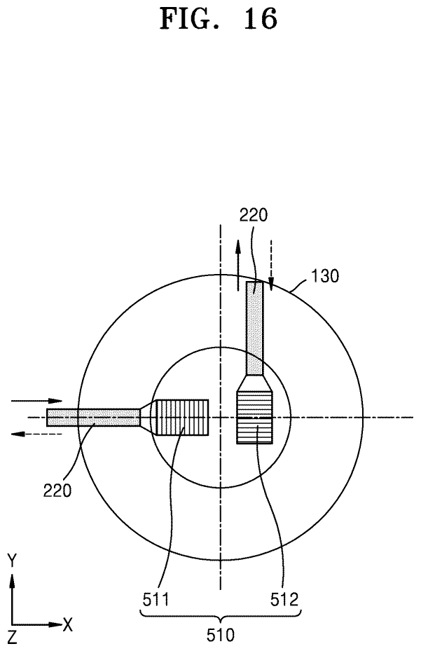

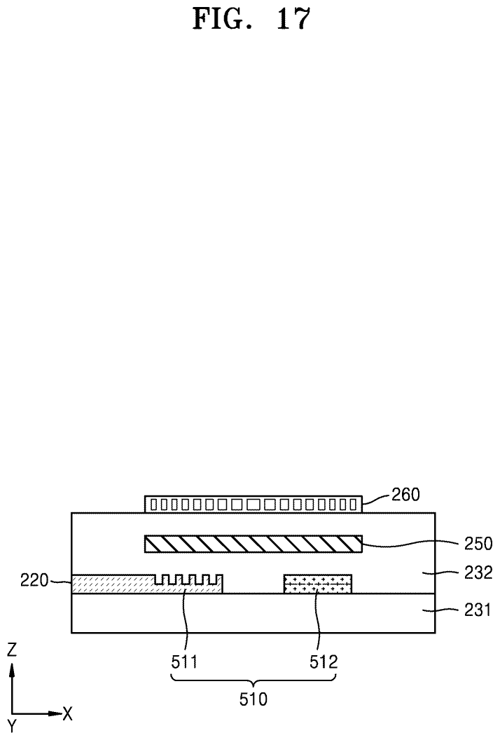

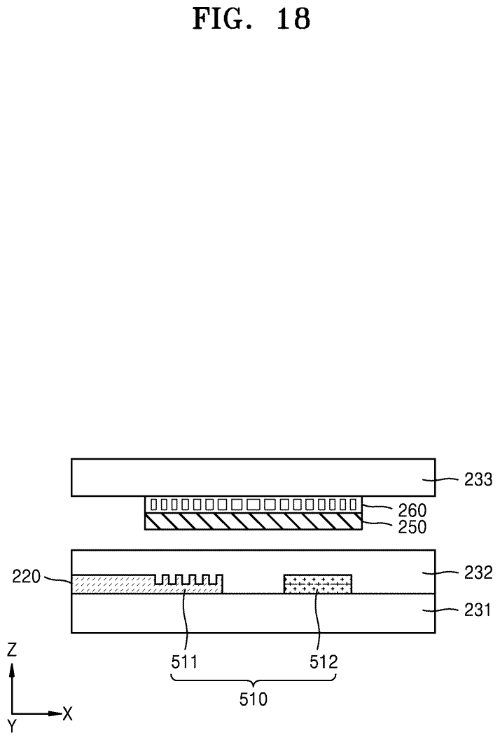

FIGS. 16 to 18 are schematic views showing a grating coupler 510 according to some embodiments. FIG. 16 shows a front view of the grating coupler 510 according to an embodiment, and FIGS. 17-18 show side views of the grating coupler 510 according to embodiments. Differences between elements are described with reference to FIGS. 11 to 13, and repeated descriptions may be omitted.

Referring to FIGS. 16 to 18, the QWP 250 may be provided between the grating coupler 510 (e.g., a transmission grating coupler 511 and a reception grating coupler 512) and the GP deflector 260. The QWP 250 may be provided, for example, in the cladding layer 232 as in FIG. 17, or on the separate substrate 233 together with the GP deflector 260, above the cladding layer 232, as in FIG. 18.

The transmission grating coupler 511 and the reception grating coupler 512 may be configured to couple linearly polarized light. The transmission grating coupler 511 and the reception grating coupler 512 may share the QWP 250. In this case, a difference between polarization directions of a transmission light beam and a reception light beam may be 90 degrees.

For example, a transmission light beam output from the transmission grating coupler 511 may be linearly polarized LP in the first direction (e.g., the X direction), and the light beam that is linearly polarized in the first direction (e.g., the X direction) may be left-circularly polarized LCP by the QWP 250. The left-circularly polarized light beam LCP may be right-circularly polarized RCP by the GP deflector 260 and be directed toward a target object (e.g., the target object 10). The light beam reflected from the target object (e.g., the target object 10) may be left-circularly polarized, and the left-circularly polarized light beam may be modulated to a right-circularly polarized light beam by the GP deflector 260. The right-circularly polarized light beam RCP may be linearly polarized in the second direction (e.g., the Y direction) by the QWP 250 and the reception light beam linearly polarized in the second direction (e.g., the Y direction) may be coupled by the reception grating coupler 512. As described above, the difference between polarization directions of the transmission light beam and the reception light beam may be 90 degrees.

Therefore, considering the polarization directions of the transmission light beam and the reception light beam, the transmission grating coupler 511 and the reception grating coupler 512 may extend perpendicular to each other such as to form an angle that is approximately 90 degrees, as shown in FIG. 16.

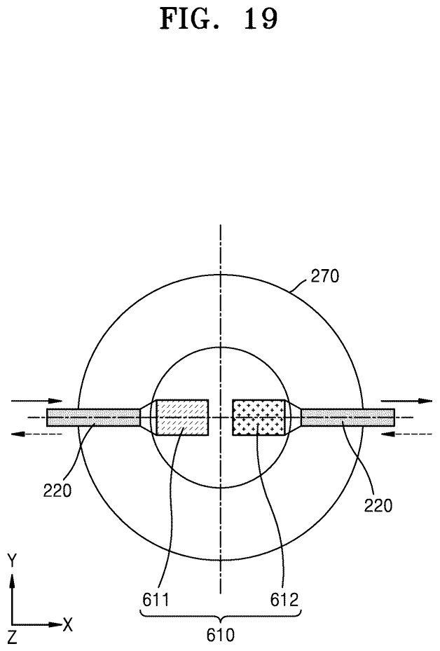

FIGS. 19 to 21 are schematic views showing a grating coupler 610 according to some embodiments. FIG. 19 shows a front view of the grating coupler 610 according to an embodiment, and FIGS. 17-18 show side views of the grating coupler 610 according to an embodiment. Differences between elements are described with reference to FIGS. 11 to 13, and repeated descriptions may be omitted.

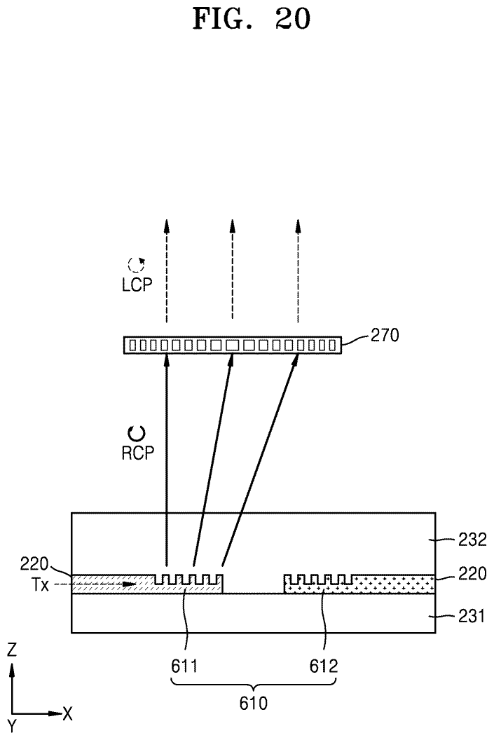

Referring to FIGS. 19 to 21, a GP deflector lens 270 may be provided instead of the imaging lens 130 and the GP deflector 260 of FIGS. 11 to 13. The GP deflector lens 270 may include liquid crystals or a plurality of nanostructures. The nanostructures may constitute a meta surface. Referring to FIG. 20, a light beam output from a transmission grating coupler 611 may be, for example, a right-circularly polarized light beam RCP. The GP deflector lens 270 may cause the right-circularly polarized light beam RCP output from the transmission grating coupler 611 to be left-circularly polarized LCP, form parallel light, and be directed toward a target object (e.g., the target object 10).

The light beam reflected from the target object (e.g., the target object 10) may be right-circularly polarized RCP. The GP deflector lens 270 may refract and focus the right-circularly polarized light beam RCP toward the reception grating coupler 612 while polarizing the right-circularly polarized light beam RCP to a left-circularly polarized light beam LCP.

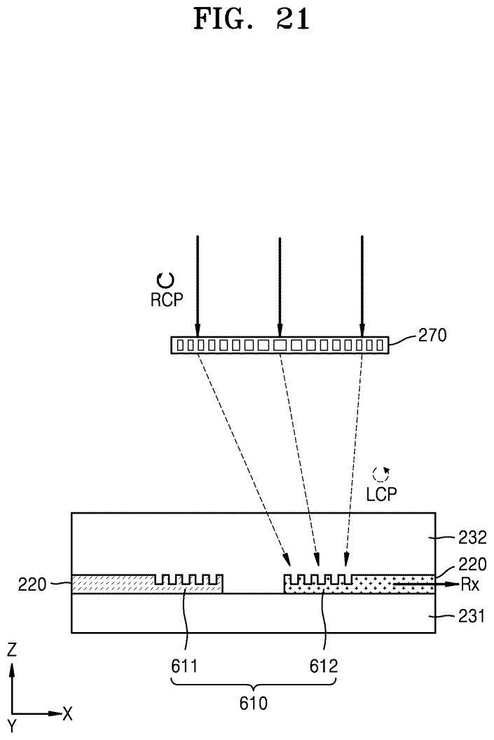

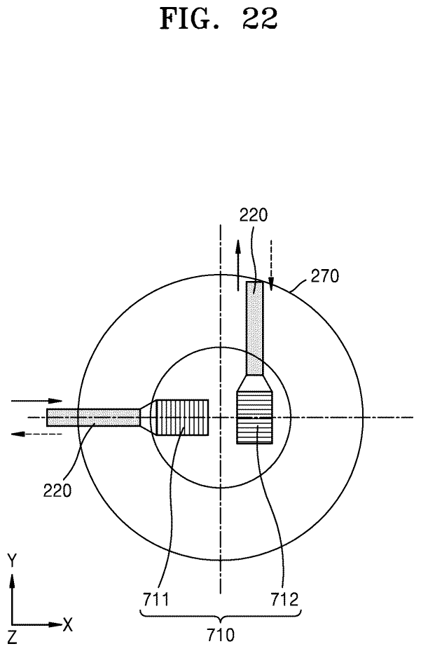

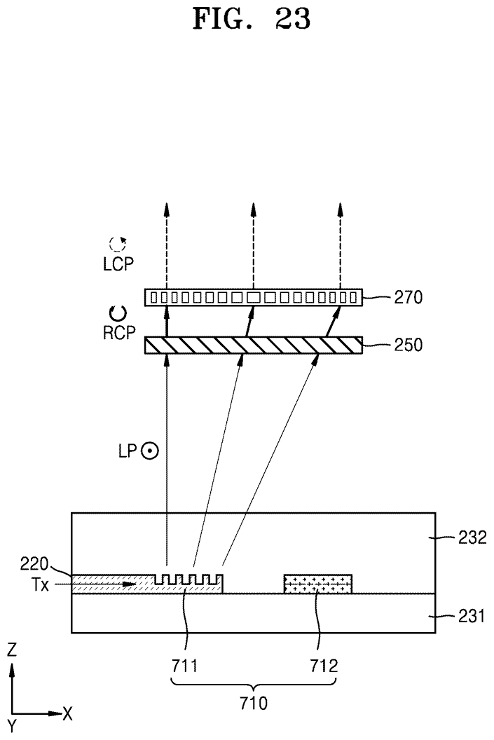

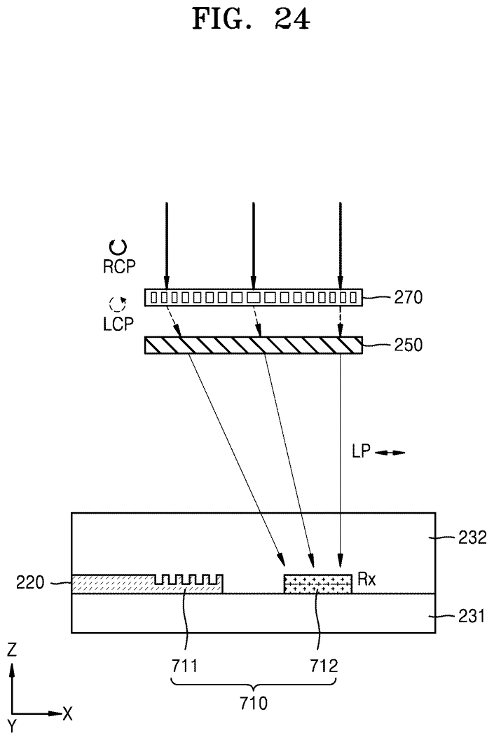

FIGS. 22 to 24 are schematic views showing a grating coupler 710 according to some embodiments. FIG. 21 shows a front view of the grating coupler 710 according to an embodiment, and FIGS. 23-24 show side views of the grating coupler 610 according to an embodiment. Differences between elements are described with reference to FIGS. 19 to 21, and repeated descriptions may be omitted.

Referring to FIGS. 22 to 24, the QWP 250 may be provided below the GP deflector lens 270. For example, as shown in FIGS. 23 to 24, the QWP 25 may be provided below the GP deflector lens 270, above the cladding layer 232. A transmission grating coupler 711 and a reception grating coupler 712 may share the QWP 250. The transmission grating coupler 711 and the reception grating coupler 712 may be configured to couple linearly polarized light LP, and the difference between polarization directions of the transmission light beam and the reception light beam may be 90 degrees.

For example, a transmission light beam output from the transmission grating coupler 511 may be linearly polarized in the second direction (e.g., the Y direction), and the light beam that is linearly polarized in the second direction (e.g., the Y direction) may be right-circularly polarized by the QWP 250 to be right-circularly polarized light RCP. The right-circularly polarized light beam RCP may be left-circularly polarized LCP by the GP deflector lens 270 and be directed toward a target object (e.g., the target object 10). The light beam reflected from the target object (e.g., the target object 10) may be right-circularly polarized to be a right-circularly polarized light beam RCP, and the right-circularly polarized light beam RCP may be left-circularly polarized LCP by the GP deflector lens 270 to be a left-circularly polarized light beam. The left-circularly polarized light beam LCP may be linearly polarized in the first direction (e.g., the X direction) by the QWP 250 and the reception light beam linearly polarized in the first direction (e.g., the X direction) may be coupled by the reception grating coupler 512. As described above, the difference between polarization directions of the transmission light beam and the reception light beam may be 90 degrees.

Therefore, considering the polarization directions of the transmission light beam and the reception light beam, the transmission grating coupler 711 and the reception grating coupler 712 may extend perpendicular to each other such as to form an angle that is approximately 90 degrees, as shown in FIG. 22.

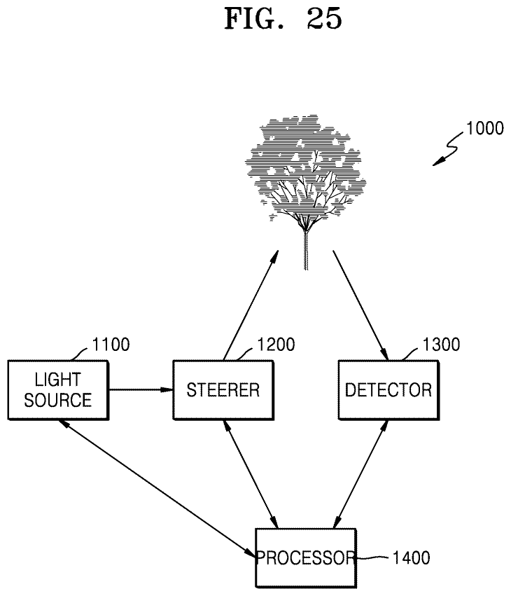

FIG. 25 is a view of a LiDAR device 1000 according to an embodiment.

The LiDAR device 1000 may include a light source 1100 generating light, a steerer 1200 steering light output from the light source 1100 toward a target object, a detector 1300 detecting light reflected from the target object, and a processor 1400 performing an operation to obtain information about the target object from the light detected by the detector 1300. The LiDAR device 1000 may further include a plurality of waveguides providing optical connections between the light source 1100 and the steerer 1200, and between the steerer 1200 and the detector 1300. The light source 1100, the steerer 1200, the detector 1300, and the processor 1400 may be implemented as separate devices or as one device.

According to embodiments, processor 1400 may be provided with memory to perform functions of the processor 1400 described herein and/or other functions by the processor 1400 loading corresponding computer code or instructions on the memory and executing the computer code or instructions. For example, the computer code or instructions in the memory, when executed by the processor 1400, may be configured to cause the processor 1400 to perform its functions.

The LiDAR device 1000 may be a frequency-modulated continuous wave (FMCW) LiDAR device. The LiDAR device 1000 may transmit FMCW light, which is a frequency-modulated continuous wave, detect the reflected wave reflected from the target object, and calculate a distance between the LiDAR device 1000 and the target object by using a frequency difference between waveforms of the detection signal and waveforms of the transmission signal.

The light source 1100 may be a tunable laser that may control a wavelength of emitted light. A plurality of laser beams may be emitted from the light source 1100 and, among these plurality of laser beams, laser beams having optical coherence with each other may be incident on the steerer 1200. The light source 1100 may generate and output light having a plurality of different wavelength bands. Also, the light source 1100 may generate and output pulsed light or continuous light.

The light source 1100 may include a laser diode (LD), an edge emitting laser, a vertical-cavity surface emitting laser (VCSEL), a distributed feedback laser, a light emitting diode (LED), a super luminescent diode (SLD), etc.

The light source 1100 may be directly coupled (e.g., on-chip) or indirectly coupled (e.g., off-chip) to the waveguide. An on-chip light source may be implemented through III-V bonding or epitaxial growth. An off-chip light source may be implemented by utilizing vertical coupling, edge coupling, or chip alignment of an external light source.

The steerer 1200 may change the direction of light from the light source 1100 to illuminate a target object, and may include an FPA or an FPA package that may control the direction of light without mechanical movement. The FPA or the FPA package may include the FPA 100 described with reference to FIGS. 1 to 24. The steerer 1200 may transmit amplified light forward toward a local area by a one-dimensional (1D) or two-dimensional (2D) scanning method.

The detector 1300 may detect light reflected from the target object and generate an electrical signal based on the detected light. The detector 1300 may include an array of light detection elements. The detector 1300 may further include a minute-level device to analyze light reflected from the target object by wavelength.

The processor 1400 may perform an operation to obtain information regarding the target object from light detected by the detector 1300. In addition, the processor 1400 may direct the processing and controlling of the entire LiDAR device 1000. The processor 1400 may obtain and process information regarding the target object. For example, the processor 1400 may obtain and process two-dimensional or three-dimensional image information. The processor 1400 may control the overall operation of the light source 1100, the steerer 1200, and the detector 1300. For example, the processor 1400 may control an electrical signal applied to an FPA device included in the steerer 1200. The processor 1400 may also interpret a distance between the target object and the LiDAR device 1000, the shape of the target object, etc., through numerical information provided by the detector 1300.

The three-dimensional image obtained by the processor 1400 may be transmitted to another unit and utilized. For example, the above information may be transmitted to the processor of an autonomous driving device, such as a vehicle or drone using the LiDAR device 1000. In addition, the above information may be used in smartphones, mobile phones, personal digital assistants (PDA), laptops, personal computers (PC), wearable devices, and other mobile or non-mobile computing devices.

The LiDAR device 1000 according to the embodiments may be applied to a smartphone, a mobile phone, a PDA, a laptop, a PC, a wearable device, etc. For example, a smartphone may extract depth information of subjects in an image, adjust out-of-focus images, or automatically identify subjects in an image by using the LiDAR device 1000, which may be an object 3D sensor.

Additionally, the LiDAR device 1000 according to the embodiments may be applied to a vehicle. The vehicle may include a plurality of LiDAR devices 1000 located at various positions. By using the LiDAR device 1000, the vehicle may provide various information about the inside or surroundings of the vehicle to a driver and automatically recognize objects or people in the image to provide information necessary for autonomous driving.

According to the embodiments, the FPA with reduced light loss and the LiDAR device including the FPA may be provided.

According to the disclosed embodiment, the FPA and the grating coupler of the LiDAR device including the FPA may have structures that may separate light paths and reduce light loss.

The example embodiments described herein should be considered in a descriptive sense only and not for purposes of limitation. Descriptions of features or aspects within each embodiment should typically be considered as available for other similar features or aspects in other embodiments of the present disclosure. While one or more non-limiting example embodiments have been described with reference to the figures, it will be understood by one of ordinary skill in the art that various changes in form and details may be made therein without departing from the spirit and scope of the present disclosure.

What is claimed is:

1. A focal plane array comprising:
a plurality of pixels configured to output a transmission light beam to a target object and receive, based on the transmission light beam, a reception light beam reflected from the target object,
wherein each of the plurality of pixels comprises:
a transmission grating coupler;
a reception grating coupler, and
a geometric phase (GP) optical device,
wherein the transmission grating coupler is configured to output the transmission light beam such that the transmission light beam has a first polarization direction and is incident on the GP optical device, and the GP optical device is configured to modulate the transmission light beam from the first polarization direction to a second polarization direction, different from the first polarization direction, and
wherein the reception light beam reflected from the target object has a third polarization direction, the GP optical device is further configured to modulate the reception light beam from the third polarization direction to a fourth polarization direction, different form the third polarization direction, and the reception grating coupler is further configured to receive the reception light beam having the fourth polarization direction.

2. The focal plane array of claim 1, wherein
the GP optical device is a GP lens, a GP deflector, or a GP deflector lens, and the GP optical device comprises a liquid crystal or a plurality of nanostructures,
the first polarization direction is one from among a left-circular polarization and a right-circular polarization, the second polarization direction is one from among the left-circular polarization and the right-circular polarization that is different from the first polarization direction, and
the third polarization direction is one from among the left-circular polarization and the right-circular polarization, and the fourth polarization direction is one from among the left-circular polarization and the right-circular polarization that is different from the third polarization direction.

3. The focal plane array of claim 2, wherein the GP optical device is the GP lens,
the first polarization direction and the fourth polarization direction are each either the left-circular polarization or the right-circular polarization, and
the second polarization direction and the third polarization direction are each either the left-circular polarization or the right-circular polarization that is different from the first polarization direction and the fourth polarization direction, respectively.

4. The focal plane array of claim 1, wherein the GP optical device is a GP lens, the transmission grating coupler is larger than the reception grating coupler, and the reception grating coupler is on the transmission grating coupler.

5. The focal plane array of claim 2, wherein the GP optical device is the GP lens, the reception grating coupler is larger than the transmission grating coupler, and the transmission grating coupler is on the reception grating coupler.

6. The focal plane array of claim 2, wherein the GP optical device is the GP lens, and
the focal plane array further comprises a quarter wave plate between the transmission grating coupler and the GP optical device.

7. The focal plane array of claim 6, wherein
each of the plurality of pixels further comprises a buried oxide (BOX) layer, and a cladding layer on the BOX layer,
the reception grating coupler is on the BOX layer,
the transmission grating coupler is on the cladding layer and apart from the reception grating coupler, and
the GP optical device and the quarter wave plate overlap with the cladding layer and are apart from the transmission grating coupler.

8. The focal plane array of claim 6, wherein
each of the plurality of pixels further comprises a buried oxide (BOX) layer, and a cladding layer on the BOX layer,
the reception grating coupler is on the BOX layer,
the transmission grating coupler is in the cladding layer and apart from the reception grating coupler,
the focal plane array further comprises a substrate that is apart from the cladding layer, and
the GP optical device and the quarter wave plate are on the substrate.

9. The focal plane array of claim 2, wherein the GP optical device is the GP deflector,
the first polarization direction and the third polarization direction are each one from among the left-circular polarization or the right-circular polarization, and
the second polarization direction and the fourth polarization direction are each the other from among the left-circular polarization and the right-circular polarization.

10. The focal plane array of claim 2, wherein
the GP optical device is the GP deflector,
each of the plurality of pixels further comprises a buried oxide (BOX) layer, and a cladding layer on the BOX layer, and
the transmission grating coupler and the reception grating coupler are spaced apart from each on the BOX layer, and extend in opposite directions with respect to each other.

11. The focal plane array of claim 2, wherein
the GP optical device is the GP deflector,
each of the plurality of pixels further comprises a buried oxide (BOX) layer, and a cladding layer provided on the BOX layer,
the transmission grating coupler and the reception grating coupler are spaced apart from each other on the BOX layer, and extend in opposite directions with respect to each other,
the focal plane array further comprises a substrate that is apart from the cladding layer, and
the GP optical device is on the substrate.

12. The focal plane array of claim 2, wherein
the GP optical device is the GP lens,
the focal plane array further comprises a quarter wave plate that is between the transmission grating coupler and the GP optical device and between the reception grating coupler and the GP optical device,
each of the plurality of pixels further comprises a buried oxide (BOX) layer, and a cladding layer provided on the BOX layer, and
the transmission grating coupler and the reception grating coupler are spaced apart from each other on the BOX layer, and extend perpendicular to each other.

13. The focal plane array of claim 2, wherein
the GP optical device is the GP lens,
the focal plane array further comprises a quarter wave plate between the transmission grating coupler and the GP optical device and between the reception grating coupler and the GP optical device,
each of the plurality of pixels further comprises a buried oxide (BOX) layer. and a cladding layer on the BOX layer,
the transmission grating coupler and the reception grating coupler are spaced apart from each other on the BOX layer, and extend perpendicular to each other,
the focal plane array further comprises a substrate that is apart from the cladding layer, and
the GP optical device and the quarter wave plate are on the substrate.

14. The focal plane array of claim 2, wherein the GP optical device is the GP deflector lens,
the first polarization direction and the third polarization direction are each one from among the left-circular polarization and the right-circular polarization, and
the second polarization direction and the fourth polarization direction are each the other from among the left-circular polarization and the right-circular polarization.

15. The focal plane array of claim 1, wherein the GP optical device is a GP deflector lens,
each of the plurality of pixels further comprises a buried oxide (BOX) layer, and a cladding layer on the BOX layer, and
the transmission grating coupler and the reception grating coupler are on the BOX layer, and extend in opposite directions with respect to each other.

16. The focal plane array of claim 1, wherein
the GP optical device is a GP deflector lens,
the focal plane array further comprises a quarter wave plate between the transmission grating coupler and the GP deflector lens, and the reception grating coupler and the GP deflector lens,
each of the plurality of pixels further comprises a buried oxide (BOX) layer, and a cladding layer on the BOX layer, and
the transmission grating coupler and the reception grating coupler are on the BOX layer, and extend perpendicular to each other.

17. The focal plane array of claim 1, wherein
the focal plane array further comprises:
a first waveguide connected to the transmission grating coupler; and
a second waveguide connected to the reception grating coupler, and
an angle between the first waveguide and the second waveguide is 0 degrees, degrees, or 180 degrees.

18. A light detection and ranging (LiDAR) device comprising:
a light source configured to output a light;
a steerer configured to steer the light;
a detector configured to detect the light after the light is reflected; and
a processor configured to perform an operation based on the light that is detected by the detector,
wherein the steerer comprises:
a plurality of pixels configured to output a transmission light beam to a target object and receive, based on the transmission light beam, a reception light beam reflected from the target object,
wherein each of the plurality of pixels comprises:
a transmission grating coupler;
a reception grating coupler; and
a geometric phase (GP) optical device,
wherein the transmission grating coupler is configured to output the transmission light beam such that the transmission light beam has a first polarization direction and is incident on the GP optical device, and the GP optical device is configured to modulate the transmission light beam from the first polarization direction to a second polarization direction, and
wherein the reception light beam reflected from the target object has a third polarization direction, the GP optical device is further configured to modulate the reception light beam from the third polarization direction to a fourth polarization direction, and the reception grating coupler is further configured to receive the reception light beam having the fourth polarization direction.

19. The LiDAR device of claim 18, wherein
the GP optical device is a GP lens, a GP deflector, or a GP deflector lens,
the first polarization direction is one from among a left-circular polarization and a right-circular polarization, the second polarization direction is one from among the left-circular polarization and the right-circular polarization that is different from the first polarization direction, and
the third polarization direction is one from among the left-circular polarization and the right-circular polarization, and the fourth polarization direction is one from among the left-circular polarization and the right-circular polarization that is different from the third polarization direction.

20. The LiDAR device of claim 18, wherein the transmission grating coupler and the reception grating coupler are vertically stacked on each other, or are on a same vertical level as each other.
